(19) United States
(12) Patent Application Publication
(10) Pub. No.: US 2008/0121757 A1
(43) Pub. Date: May 29, 2008

(54) PASSENGER SEATS

(76) Inventors: Alexander N. Pozzi, Salem, NC (US); Mike Quary, Ardmore, OK (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/854,587

(22) Filed: Sep. 13, 2007

Related U.S. Application Data
(60) Provisional application No. 60/845,403, filed on Sep. 18, 2006.

(51) Int. Cl. A47C 7/62; A47C 31/00; B64D 11/06

(52) U.S. Cl. 244/118.6; 297/217.3

(57) ABSTRACT

Seating assemblies, principally for passenger vehicles such as aircraft, are detailed. Memory devices associated with the seats may receive information in the form of seat-adjustment preferences for the passengers to whom the seats are assigned for a journey. The information may be provided directly by a passenger while on-board the vehicle or in advance of the journey. Crew overrides of the adjustment preferences may occur. The seats additionally may include alarms or provide other functionality of interest to passengers and authorities.

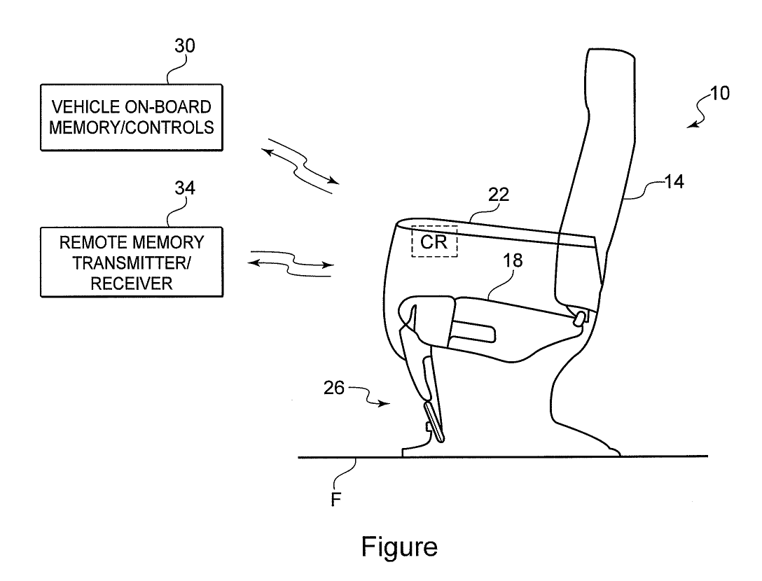

### CROSS REFERENCE TO RELATED APPLICATION

This application claims priority to U.S. Provisional Application No. 60/845,403 entitled “Passenger Seats” filed on Sep. 18, 2006, the contents of which are incorporated herein by reference.

### FIELD OF THE INVENTION

This invention relates to seats and more particularly, although not necessarily exclusively, to vehicle passenger seats adapted for wireless, remote actuation. The seats additionally or alternatively may be programmed remotely before vehicle operation commences and adapted to recognize seat-related or other preferences of a particular passenger.

### BACKGROUND OF THE INVENTION

Enhancing passenger comfort and convenience remain important goals of seat designers and manufacturers. Increasing safety of passengers seated in common carriers and other vehicles likewise is a significant objective of designers and manufacturers. Accordingly, airlines and others responsible for human transit continue to seek to improve comfort, convenience, and safety of passengers seated in their care.

Commonly-owned U.S. Pat. No. 6,237,994 to Bentley, et al. details exemplary multi-function seats. Embodiments of the seats may incorporate a touch-screen control panel in the form of a liquid crystal display (LCD) or similar device. Such device may be programmed to provide protocol for passenger interaction with the seat control actuators and scroll-down or multi-screen menus of options for managing adjustment of the seat. The device as well may support at least temporary storage of personalized settings for various adjustments, allowing a passenger to return the seat to a specific position upon command. See Bentley, col. 2, ll. 26-34. As noted in the Bentley patent, individual control panels also may be linked to a cabin communication system to allow passengers to contact attendants. Seat diagnostic information additionally may be developed.

U.S. Pat. No. 6,929,218 to Sanford, et al. discloses aircraft seat assemblies in which modular options are incorporated into the seats. These options are intended to encompass flight essential seat options . . . such as passenger supplemental oxygen deployment, proximity lighting, attendant call button, attendant call signal light, and built-in test equipment. The modular seat options are further intended to include non-essential seat options such as detection components (i.e. seatbelt detect, upright seat detect, tray stow detect, and tampering detect for items such as lifejackets), optional power supply such as for computers, in-seat reading lights, information lights, in-seat entertainment, seat controls, passenger address, and gasper fan. See Sanford, col. 2, ll. 54-65 (numerals omitted). Each option communicates with an electronic control system adapted to monitor seat and tray table position and whether the safety belt associated with the seat is latched. The control system, further, may communicate wirelessly with a central monitoring system.

Detailed in U.S. Pat. No. 6,964,481 to Pho, et al. is a system for transmitting signals to projectors within vehicle seats. Each projector projects an “optical signal with seat identifying information onto the seatback of [an adjacent] seat.” See Pho, Abstract, ll. 8-9. When a particular door of the vehicle opens, the projectors are activated wirelessly.

U.S. Pat. No. 6,963,292 to White discusses methods for reporting emergencies aboard aircraft. Passengers may manually or wirelessly activate panic devices on-board airplanes. Activation results in transmission of an emergency signal outside of the aircraft.

### SUMMARY OF THE INVENTION

The present invention provides seats having additional or alternative functionality than those described in the preceding section. Memory devices associated with a seat may receive information in the form of seat-adjustment preferences for the passenger to whom the seat is assigned for a journey. Such information may be provided via an internet (or other) reservations or other system. It alternatively or additionally could be provided manually by the passenger or determined via a database review based, for example, on a passenger's frequent traveler program identifier.

Seats of the invention additionally may include time-based or other alarms (settable by passengers or crew) and allow messages to be displayed to passengers. Wireless telephone, radiotelephone, videoconference, or similar service may be provided for each seat to permit communication both within and external of the associated vehicle, and music, connecting gate information, arrival weather reports, or other information (audio, video, data, or otherwise) may be uploaded or downloaded. Further, attendants or other vehicle crew members or authorities may override seat settings and force seats into particular configurations during emergencies or take-offs and landings of aircraft, for example.

Hence, seat assemblies of the present invention may serve as repositories of information about the passengers to which they are assigned for particular trips, transmitters of information relating to passenger needs and desires, and receivers of information from authorities or otherwise designed to increase passenger safety. Transmission and receipt of information may occur via wire or wirelessly through radio frequency (RF), infrared (IR), or other signals. Portable transmitters and card readers also may be employed to transmit and receive information.

It thus is an optional, non-exclusive object of the present invention to provide seat assemblies having improved or novel functionality.

It is another optional, non-exclusive object of the present invention to provide seat assemblies adapted automatically to receive adjustment information for passengers.

It is an additional optional, non-exclusive object of the present invention to provide seat assemblies in which adjustment or other information based on passenger preferences is transmitted wirelessly to individual seats.

It is a further optional, non-exclusive object of the present invention to provide seat assemblies in which adjustment or other information is transmitted wirelessly to individual seats based on decisions made, or information provided by, attendants, authorities, or cabin crew.

It is, moreover, an optional, non-exclusive object of the present invention to provide seat assemblies functioning as repositories for information relating to the passengers assigned to the seats during a voyage.

It is yet another optional, non-exclusive object of the present invention to provide seat assemblies adapted to wirelessly transmit information relating to passenger needs and wirelessly receive information for presentation to passengers.

Other objects, features, and advantages of the present invention will be apparent to those skilled in appropriate fields with reference to the remaining text and drawings of this application.

### BRIEF DESCRIPTION OF THE DRAWING

The FIGURE illustrates a passenger seat and associated equipment and functions of the present invention.

### DETAILED DESCRIPTION

Depicted in the FIGURE is exemplary seat 10 consistent with the present invention. Seat 10 is shown connected to floor F of an aircraft, ship, or other vehicle. Seat 10 may be connected other than to floor F, however, and may be deployed other than in an aircraft or ship. Likewise, although seat 10 is illustrated as having back 14, platform 18, armrest 22, and footrest assembly 26, it may be constructed differently than detailed in the FIGURE and may omit any of these features.

Shown in dotted lines in the FIGURE is device CR. Device CR may be (or include) any useable apparatus configured to receive and at least temporarily retain information concerning a passenger to be seated in seat 10. In some versions of the invention, device CR includes a magnetic-card reader and associated memory. Device CR alternatively (or additionally) may include a touch-screen device, membrane keypad, keyboard, or other structure. If device CR is accessible to a passenger, he or she may cause it to read information stored on his or her frequent flyer card, for example, transferring such information to the associated memory.

Information transferred to the associated memory may include preferred adjustments of seat 10. This information allows a passenger to customize adjustment of the seat 10 as desired based on pre-existing preferences stored on the frequent flyer card (or elsewhere). Non-limiting examples of other information that may be stored on the card and transferred to the memory could include meal or beverage preferences (both content and timing), frequent-flyer status, sleep preferences (including timing of wake-up alarm), language preferences, immigration status, and entertainment preferences (again both content and timing).

Alternatively or additionally, device CR may be configured to allow the passenger to input real-time information as to adjustments of seat 10 or any of the other information provided to the memory. Thus, for example, a passenger could override for a particular journey a preference stored on the card. Similarly, if a particular preference is not stored on the card, it could be set as needed by the passenger for the journey.

Device CR is depicted in the FIGURE as being formed within, or connected to, armrest 22 of seat 10. In some embodiments of the invention, part of all of device CR may be located either elsewhere within seat 10 or in back 14 of a seat immediately in front of seat 10. Device CR alternatively may be located elsewhere in the cabin of an aircraft or ship or even, conceivably, in a location remote from any vessel in which seat 10 is placed. Depending on placement, memory and the reader or other information-accepting apparatus of device CR may communicate via wire or wirelessly.

Device CR may be configured also to receive information from one or more sources other than the passenger assigned to the seat 10. As illustrated in the FIGURE, device CR may include a transmitter and receiver so as to communicate with on-board memory/controls 30. Such communication preferably, although not necessarily, occurs wirelessly. In this manner, cabin crew may, for example, override a passenger's seat-adjustment preferences and cause seat 10 to adopt a particular position when necessary. This is particularly appropriate for take-offs and landings of aircraft, when seat 10 typically must be in the upright position shown in the FIGURE. Device CR of seat 10 also could communicate information to on-board memory/controls 30 such as whether the passenger has engaged a seat-belt of seat 10, whether seat 10 is positioned or oriented in a particular manner, or whether the passenger is attempting to summon an attendant for assistance. It additionally could provide diagnostic information concerning the operational status of seat 10 including, for example, the number of actuation cycles (recline, upright) to which the seat 10 has been subjected, whether maintenance is required, when any warranty expires, or when, where, or by whom maintenance previously was performed.

Communication also may occur between device CR and remote transmitter/receiver 34. If, for example, passenger preferences are set when a reservation is made (via the internet or otherwise) for seat 10 for a particular journey, the preferences may be transferred directly from a remote memory to seat 10 at an appropriate time. Alternatively, information from or to transmitter/receiver 34 may be transferred via on-board memory/controls 30. In either circumstance, utilizing satellites or any appropriate external communications technology, device CR may (directly or indirectly) communicate in real-time during flight or voyage with remote transmitter/receiver 34.

The foregoing is provided for purposes of illustrating, explaining, and describing embodiments of the present invention. Modifications and adaptations to these embodiments will be apparent to those skilled in the art and may be made without departing from the scope or spirit of the invention. The contents of the Bentley, Sanford, Pho, and White patents are incorporated herein in their entireties by this reference.

What is claimed is:

1. An aircraft seat for use by a passenger during a flight of the aircraft, the seat comprising:
a. means for electronically receiving information concerning passenger in-flight preferences; and
b. means for storing the received information.

2. An aircraft seat according to claim 1 in which the information receiving means comprises a magnetic card reader.

3. An aircraft seat according to claim 2 in which the information concerning passenger in-flight preferences is stored on a card configured to be read by the magnetic card reader.

4. An aircraft seat according to claim 1 in which the information receiving means comprises a receiver configured to communicate with memory/controls on-board the aircraft.

5. An aircraft seat according to claim 1 in which the information receiving means comprises a receiver configured to communicate with a transmitter remote from the aircraft.

6. An aircraft seat according to claim 5 in which the receiving communicates with a satellite.

7. An aircraft seat according to claim 1 further comprising an arm rest and in which the information receiving means is positioned at least partially within the arm rest.

8. An aircraft seat according to claim 1 further comprising:
a. a back;
b. a platform; and
c. an armrest.

9. An aircraft seat according to claim 1 further comprising means for overriding the passenger in-flight preference information received by the information receiving means.

10. An aircraft seat according to claim 9 in which the overriding means comprises means for receiving electronic override signals from crew of the aircraft.

11. An aircraft seat according to claim 9 in which the overriding means comprises means for receiving override information from the passenger.

12. An aircraft seat according to claim 1 in which the passenger in-flight preference information comprises information selected from the group consisting of preferred seat adjustment, meal preference, beverage preference, frequent-flyer status, sleep preference, language preference, immigration status, and entertainment preference.

13. An aircraft seat according to claim 1 further comprising means for transmitting information to either or both of an on-board receiver or a receiver external to the aircraft.

14. An aircraft seat according to claim 13 in which the transmitted information comprises diagnostic information concerning operational status of the seat.

15. A seat for use by a passenger during transit of a vehicle, the seat comprising:
a. means for electronically receiving information concerning passenger in-transit preferences; and
b. means for storing the received information.

16. An aircraft comprising:
a. at least one transmitter and at least one receiver adapted for interaction with crew of the aircraft; and
b. a plurality of passenger seats, each seat comprising:
i. means for electronically receiving information (A) concerning in-flight preferences of the passenger using the seat and (B) transmitted by the transmitter adapted for interaction with the crew; and
ii. means for storing at least the received information concerning in-flight preferences of the passenger using the seat.
